(19) United States
(12) Patent Application Publication
(10) Pub. No.: US 2022/0343376 A1
(43) Pub. Date: Oct. 27, 2022

(54) Method and System for Online Marketing with Supply Chain Profit Management

(71) Applicant: Tian GUO, Eastvale, CA (US)

(72) Inventor: Tian GUO, Eastvale, CA (US)

(21) Appl. No.: 17/239,557

(22) Filed: Apr. 24, 2021

(51) Int. Cl. G06Q 30/02; G06Q 30/06; G06Q 10/10

(52) U.S. Cl. CPC G06Q 30/0282; G06Q 30/0623; G06Q 10/10; G06Q 30/0222

(57) ABSTRACT

A system for online marketing with supply chain profit management includes a computer usable medium having computer-readable program code embodied in the medium to perform executable operations, including managing a plurality of marketing products on sale, providing access to a product information and a plurality of suppliers in a supply chain of the product, allowing a consumer user to review and grade one or more of the suppliers through a user interface, and allowing the consumer user to assign one or more profit shares with respect to one or more of the suppliers in the supply chain of the product through the user interface.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to computer-implemented method and system for profit management of e-commerce, and more particularly to a method and system for online marketing with supply chain profit management.

### Description of Related Arts

In a conventional online marketing business model, a seller provides and sells products or services on an online marketing platform such as Amazon, eBay, Apple.com, Taobao.com, Wallmart.com, Costco.com, Jingdong.com, tmall.com, Alibaba, and etc. A customer purchases the product in the e-commerce platform and the product is delivered to the customer by a logistics supplier. The logistics supplier can be the online marketing platform such as Amazon, Jingdong, etc., or a third party logistics supplier such as UPS, US Postal Service, etc. In the conventional online marketing platform, the seller shows and sells a product on a product webpage of the platform with description and price of the product. The customer acquires the brand of the product, the feature and/or function of the product, and the price of the product on the platform. To the customer, the price of the product is an important factor to affect the customer to purchase the product or not besides the description and brand name of the product.

In a conventional pricing method for selling products, cost plus profit is the most common and popular pricing method. The selling price shown on the product webpage is determined by the seller. Traditionally, an exporter would like to purchase the product from a manufacturer as low as possible, and the importer would like to purchase the product from the exporter as low as possible. Similarly, a brand name seller would like to purchase the products directly from a manufacturer which can provide the product in a lowest selling price with the best quality. Therefore, quantity and manufacturing cost of the product become essential factors for the manufacturer to determine the factory price with considerable profit of the product in order to run the business. Whereas some online sellers may also try to purchase brand name products from their manufacturers so as to minimize the intervening costs, such as industrial design, packaging, marketing, promotion, and etc., that results in direct and challenging competition to the original brand name sellers. In order to lower the manufacturing coast, the manufacturers would always like to make and sell more quantity in every particular product.

The supply channel of a particular product is very complex. Products are manufactured and sold across multiple manufacturers and suppliers, including but not limited to the raw materials suppliers, the mould manufacturers, the semi-product or components making manufacturers, the assembling manufacturers, the product and/or industry designers, the research and development (R&D) engineers, the packaging designers, marketing firms, the exporters, the importers, the distributors, the logistics service providers, the brand name sellers, retailers, the online sellers, and so on. However, the end seller, such as the online seller, is the one who may make the most profit out of a sale of a product. The higher the price the seller sells the product through the online marketing platform, the more profit the seller will make. But the other suppliers in the supply chain may contribute the most important effort in producing a good product generally do not have chance to share the increased profit paid by the consumers. On the contrary, these suppliers behind the online seller and the platform have to compete both in quality and quantity with the relatively lower cost in order to get the orders from the retailers or the online sellers.

Instead, if the seller makes a lower profit from the product through the online marketing, the seller may drive down the price of the manufacturer and other suppliers in the supply chain of the product. It is apparent that in order to have a good product with relatively high price and quality ratio, the manufacturers and the designers of the products should be the key entities, and that the best encouragement to these manufacturers and designers is to provide valuable rewards and profits for products they made and designed that meet the consumers requirement and please the customers rather than oppressive competition. The common way for a manufacturer to survive for a reduction of the price of the product manufacturer's product is to reduce the production cost. Of course, the cost of a product may be reduced by more reasonable management and advance production skill, but most of the suppliers such as designers and manufacturers may choose to lower cost of the raw materials, the labor cost of the workers, and/or the quality of the components of the product. In other words, the suppliers in the supply chain are those who absorb the cost and take the responsibility for the sellers to get profit as high as possible. Such currently supplying structure and profit management are untimely and not beneficial to encourage all suppliers in the supply chain to design and produce better products or to provide better services to the consumers and customers in the market.

As mentioned above, the supply chair for a product on sale to the customer includes the online seller of the product, retailer, the product manufacturer, the manufacturers of components of the product, the logistics service provider, and so on. However, only the seller is the one directly dealing with the consumers while the other suppliers in the supply chain of the product generally do not obtain information of the consumers of the product from the online market. Typically, the seller obtains information of the product and the consumers thereof from the online marketing platform and the other suppliers in the supply chain such as the product manufacturer can only get information of the product and the consumers thereof from the seller. Also, the component suppliers of the product generally are sheltered from the sellers of the product from the product manufacturer or the importer of the product.

It is apparent that in order to better enhance the research and development of the product components, it is preferred to have the feedback and suggestion from the consumers. But the current supply chain does not work this way. Instead, the product designer merely designs according to his or her imagination. The R&D engineer of a product manufacturer, for example an OEM, Original Engineering Manufacturer, develops a product based on his or her experience and the demand from its buyers, i.e. the exporters, importers, brand name sellers, retailers, or online sellers, rather than the need of the consumers. Also, a product component producer merely design and produce components according to the demands of their buyers, i.e. the product manufacturers or the assembling manufacturers, and those product manufacturers, even though they are the Original Design Manufacturer, ODM, generally design and develop products based on the requirements of their buyers, such as brand name sellers or the importers. Although we all believe that the best encouragement and promotion of designing and developing a consumer product is to have all suppliers in the supply chain of the product can listen and learn the feedback and comments from their end users or consumers, the traditional supply chain system in fact fails to achieve such ideal goal but more beneficial to the sellers as well as the online marketing platforms for obtaining their maximum profit. In addition, the product manufacturers and the component suppliers are outsiders of the sale channel and cannot adapt to the change of the online marketing rapidly.

The conventional online marketing platform, most of the product webpages just show the brand of the product, the features/functions of the product, the price of the product, and the comments of the consumers and customers. Very rare product webpages will show the manufacturers and other suppliers in the supply chain of the product. The consumers are hard to obtain related information regarding the suppliers in the supply chain from the online on the product webpages as well as online marketing platforms.

Practically, the information of who is one or more essential components of a product is important information for a consumer to decide to purchase which brand or product. For example, when one would like to purchase a notebook computer, most consumers would not only make decision based on the brands of the notebook computers, such as Apple, Dell, HP, or else, but also would like to know who is the brand supplier of the processor, such as Intel and AMD, and even the manufacturer of the processor, such as TSM, Samsung, or else. The fact is even though Intel and AMD require the brand name notebook supplier to also print their logo on the product besides its own trademark, the consumers are not convenient to find out who are the manufacturing suppliers of the processor and other hardware such as motherboard, hard drive, and screen.

In other words, the conventional online marketing platforms restrict the customers to freely choose the suppliers in the supply chain of the product. Rather, the conventional online marketing platforms just show the price of the product and seems to simply encourage the consumers to select their merchandises based on the product brands and their selling prices. May be, it is more beneficial to the online marketing platforms and the product sellers, but it is not a fair transaction to the consumers for obtaining all essentially information regarding the products before they make a choice and purchase. The consumers are preferred to be informed for the actual cost of the products and how much the suppliers are going to earned from producing and selling these products. The consumers do not mind the suppliers in the supply chain of the product making profit from manufacturing and providing the favorite and valuable products to them but most consumers believe they should have the privileges to distribute profits to their favorite suppliers in the supply chain so as to appreciate and encourage their favorite suppliers' effort in developing and making the products.

### SUMMARY OF THE PRESENT INVENTION

The invention is advantageous in that it provides a method and system for online marketing with supply chain profit management, wherein the profits of the suppliers in the supply chain are specifying according to the reviews and grades of the consumers.

The invention is advantageous in that it provides a method and system for online marketing with supply chain profit management, which is capable of arranging the profit of the product based on the product review and grading by the consumer who purchased the product, wherein the product can be a merchandise product or a service product collaboratively provided by the suppliers in the supply chain.

The invention is advantageous in that it provides a method and system for online marketing with supply chain profit management, wherein the consumer who purchased a specific merchandise product or service product is allowed to record, select, specify, and/or grade one or more reasons or factors affecting the purchase decision. For example, the purchased consumer may specify the reason or key factor of decision to purchase as one or more of the ornamental design, the internal mechanism, functions or performance, the product or service brand, the packaging, the rapid and secure logistics service, the after customer service, the warranty or maintenance service, and etc.

The invention is advantageous in that it provides a method and system for online marketing with supply chain profit management, wherein designated or specific suppliers in the supply chain of a selling merchandise product or service product is disclosed to the consumers in such a manner that the consumer user may grade the favorite degrees thereof accordingly and respectively.

The invention is advantageous in that it provides a method and system for online marketing with supply chain profit management which shows a cost and/or a profit information of the product on sale, wherein the cost and profit information of the product can be embodied as cost and/or profit ratio, percentage, proportion, code, or etc., so as to illustrate the contribution of the suppliers in the supply chain with regards as the cost and/or profit.

The invention is advantageous in that it provides a method and system for online marketing with supply chain profit management, wherein a supply chain, including one or more collaborated suppliers, of the product on sale on an online marketing platform is displayed to the consumers.

The invention is advantageous in that it provides a method and system for online marketing with supply chain profit management, wherein the cost and/or profit rate of each supplier of the product are shown on the online marketing platform.

The invention is advantageous in that it provides a method and system for online marketing with supply chain profit management, wherein the consumer user is capable of selecting the supplier of the product, such as the manufacturing supplier of the product, the essential part supplier of the product, and etc.

The invention is advantageous in that it provides a system for online marketing with supply chain profit management, which is programmed to be capable of giving a reward to one or more suppliers of the supply chain of a product according to the reviews of the consumers purchased the product.

The invention is advantageous in that it provides a method and system for online marketing with supply chain profit management, wherein the consumer who purchased the product on the online marketing platform is capable of commenting each of the suppliers of the supply chain of the product purchased by the consumer user through the online marketing platform, wherein the corresponding suppliers of the supply chain are able to review the comments of the consumers through the online marketing platform.

The invention is advantageous in that it provides a method and system for online marketing with supply chain profit management, wherein the profit of each supplier in the supply chain of a particular product is adjustable according to a contributing value measured based on the reviews and grades of the consumer users who purchased the product.

The invention is advantageous in that it provides a method and system for online marketing with supply chain profit management, which allows the consumers to recognize the brands of the suppliers in the supply chain through the online marketing platform. Therefore, even the suppliers other than the online seller in a supply chain of a product are encouraged to do their own jobs nicely to maintain goodwill and build up credit to their brands, that is helpful to provide better quality products to consumers.

The invention is advantageous in that it provides a method and system for online marketing with supply chain profit management, which allows the consumer users to select their preferred suppliers in the supply chain of a particular product through pre-ordering the product via the online marketing platform, wherein the online seller or brand name seller of that pre-ordered product may provide service for the purchasing consumer users to produce the pre-ordered product by giving orders to the selected suppliers to form the supply chain of the pre-ordered product and profit from such production service.

The invention is advantageous in that it provides a method and system for online marketing with supply chain profit management, through which the consumer user who is the one paying for the product or service becomes a substantial end purchaser (buyer) to all suppliers in the supply chain of the merchandise product or service product and determine the shares of the profit of the product among the collaborated suppliers in the supply chain.

The invention is advantageous in that it provides a method and system for managing profits between collaborated suppliers (e.g. manufacturers, designers, sellers, and etc.) in a supply chain associated with a product (such as a good or a service) provided by the suppliers. Aspects of the invention are targeted at online marketing platforms where there is multiple channel selling, such as online marketplaces, online auction and/or shopping websites, brand name shopping websites, offline shopping store with online shopping and/or ecommerce supports, social media platform, and etc.

The invention is advantageous in that it provides a method and system for online marketing with supply chain profit management, which is capable of presenting information of specific suppliers in a supply chain of a product on sale, so as to allow consumer users who purchased the product to review, record, track the suppliers through the suppliers information windows of the suppliers in the supply chain, and to allow consumers who purchased the product to assign profit shares directly to or by grading one or more suppliers in the supply chain of the product through the supplier grading portions of the suppliers in the supply chain displayed on the online marketing platform. In one aspect, the method and system further distribute profit shares assigned by the consumers who purchased the product to the corresponding suppliers in the supply chain of the product.

The invention is advantageous in that it provides a method and system for online marketing with supply chain profit management, which is embodied as a social media platform for individual members whose identity is consumer and/or supplier's personnel to chat, share, post, and inform information related to their comments in products or services purchased or provided, purchasing experiences, and works contributed to a supplier of a product or service. In this social media platform, all registered members are able to contact with each other, to follow another member, and to reward a specific member.

According to the present invention, the foregoing and other objects and advantages are attained by a method and system for online marketing with supply chain profit management for managing profits of suppliers in a supply chain of a product. For example, method and system embodying the invention provide a method to manage the profit of a product sold on an online marketing platform with the suppliers in the supply chain of the product. Online marketing platform, such as online store (e.g. Apple.com), e-commerce selling platform (Costco.com, Walmart.com), online marketplace (e.g. Amazon.com), action-style sale website (e.g. eBay.com), corporation on sale website (e.g. HP.com), and etc. may utilize embodiments of the invention to manage and distribute the profit of a product sold to the suppliers in the supply chain of the product in a way according to the reviews to the suppliers in the supply chain by the consumer who purchased the product.

According to the embodiments of the present invention, the system for online marketing with supply chain profit management may be comprised of computer executable instructions executed and processed by one or more computers to perform the various functions, actions, and steps described in detail herein, according to embodiments of the invention, wherein the term computer is intended to include any data processing device such as desktop computer, laptop computer, mobile smart device, tablet, mainframe computer, personal digital assistant, server, or any other device able to process, manage or transmit data, whether implemented with electrical, magnetic, optical, biological components or otherwise.

Computer software is implemented in the system to fulfill the perceived objects and advantages described above. Such software commonly utilizes multiple related functions and data structures. To encapsulate these related functions and data structure, the software often, for example, utilizes a standard object oriented programming (OOP) language approach.

An embodiment of the invention provides a system that enables the consumers to track information about listed suppliers in the supply chain of the product and the cost information for each of the listed suppliers, and to distribute a profit of the product that the consumer purchased. In one embodiment, the profit can be distributed to the listed suppliers in the supply chain based on designated ratios or proportions suggested by the consumer user. In one embodiment, the profit is distributed to the listed suppliers in the supply chain according to the reviews to the listed suppliers in the supply chain of the product by the consumer who purchased the product.

According to the present invention, a system for online marketing with supply chain profit management, which is a non-transitory computer readable medium, is provided, wherein the system comprises:

a computer usable medium having computer-readable program code embodied in the medium to perform executable operations, the computer-readable program code comprising:

a first executable portion for managing a plurality of marketing products on sale, wherein the first executable portion is configured, through a user interface, to;

provide access to a product information, including at least brand name and price of a product selected by a consumer user from the marketing products for purchasing, and presenting a profit information of the product; and

provide access to a plurality of suppliers in a supply chain of the product and a plurality of supplier information for the plurality of suppliers respectively, wherein each of the plurality of supplier information includes at least a contribution in production and marketing of the product;

a second executable portion operable to:

allow the consumer user who purchased the product to review and grade one or more of the plurality of suppliers in the supply chain of the product through the user interface; and

allow the consumer user to assign one or more profit shares with respect to one or more of the plurality of suppliers in the supply chain of the product through the user interface; and

a third executable portion operable for receiving the one or more profit shares assigned by the consumer user and generating a profit share report for the plurality of suppliers in the supply chain of the product.

In one embodiment, the second executable portion provides a supply chain timeline with a plurality of suppliers shown in order along the supply chain timeline, according to a sequence of collaborated suppliers in the supply chain contributed to the preparation and production of the product through time, to be displayed through the user interface.

In one embodiment, each supplier is provided with a profit window or profit bar which is adjustable by the consumer user through the user interface to assign profit share for the corresponding supplier, wherein by calculating all the assigned profit shares of all supplier nodes being adjusted by the consumer user who purchased the product.

In one embodiment, the second executable portion further provides a supplier grading window having a plurality of grade marks at each supplier node along a supply chain timeline that allows the consumer user to select to grade the corresponding supplier in the supply chain, wherein by calculating a total grade of all supplier nodes being graded by the consumer user who purchased the product, the profit share of each supplier node shown in the supply chain timeline is computed by the third executable portion based on the grade of the corresponding supplier node with respect to the total grade.

In one embodiment, the system further comprises an executable portion for allowing the consumer user to adjust a supplier profit for each supplier in the supply chain of the product purchased by the consumer user through the user interface.

In one embodiment, the first executable portion further receives a profit margin of the product from the online seller, which would be a profit proportion or percentage of a selling price of the product, and that the third executable portion calculates profit dividend from the profit margin for each supplier in the supply chain of the product according to the profit shares assigned by the consumer user who purchased the product and records in the profit share report to inform the suppliers in the supply chain of the product sold.

In one embodiment, the third executable portion of the system is also configured for exchanging the profit dividend in currency and distributes to each supplier's account after receiving the payment of the consumer user of the purchased product.

In one embodiment, the fourth executable portion further acquires comments as a kind of review of the customer user purchased the product to one or more suppliers in the supply chain of the product.

In one embodiment, alternatively, the fourth executable portion automatically assigns profit share for each supplier in the supply chain, based on the grades of the suppliers in the supply chain of the product by the consumer user who purchased the product on the user interface, instead of being assigned by the consumer user.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a schematic view of a user interface for displaying a product information according to a preferred embodiment of the present invention.

FIG. 2 is a block diagram illustrating the modules of the system for online marketing with supply chain profit management according to the preferred embodiment of the present invention.

FIG. 3 is a schematic view of the system for online marketing with supply chain profit management according to the preferred embodiment of the present invention.

FIG. 4 is a schematic view of the computer usable medium of the system for online marketing with supply chain profit management according to the preferred embodiment of the present invention.

a perspective view of a user interface for displaying a supply chain of the product according to a preferred embodiment of the present invention.

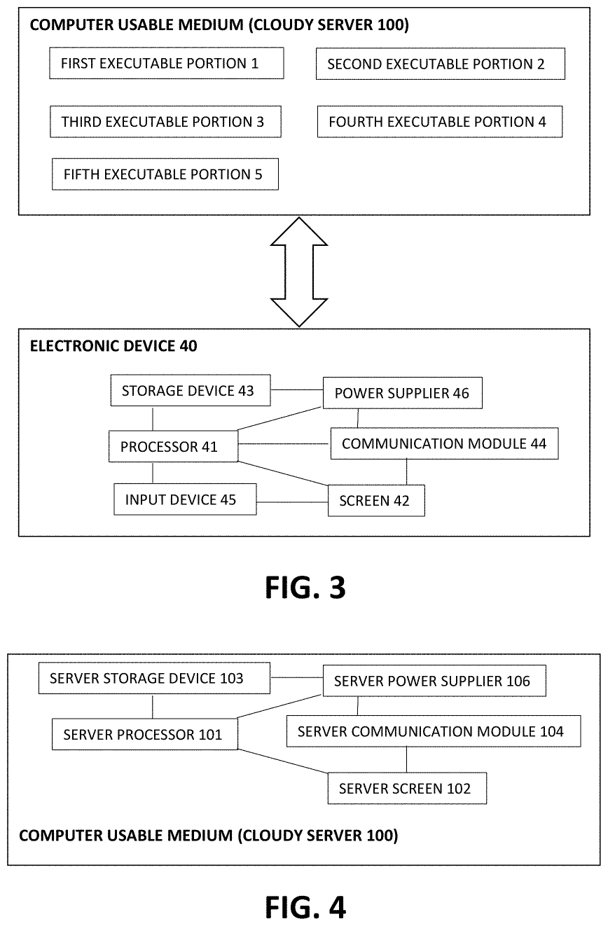

FIG. 3 is a perspective view of a user interface for displaying a supplier list according to a preferred embodiment of the present invention.

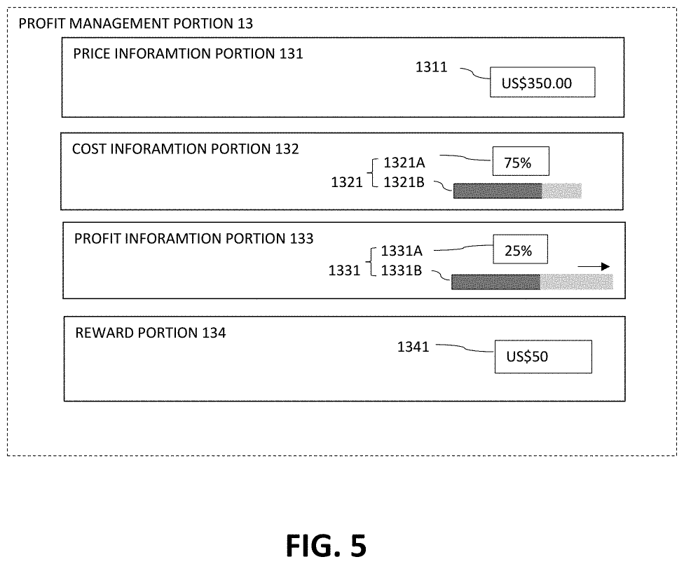

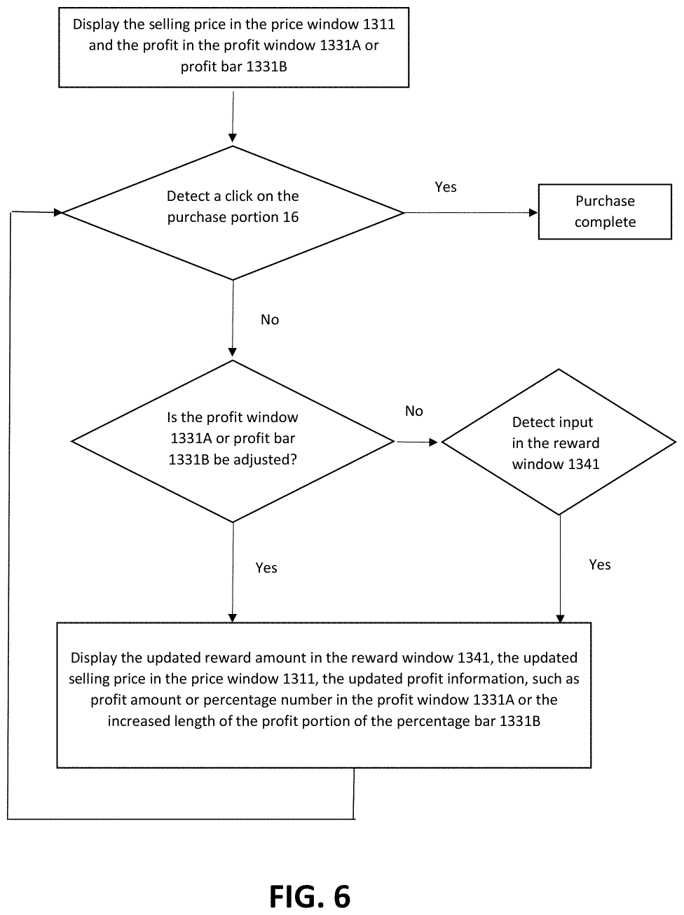

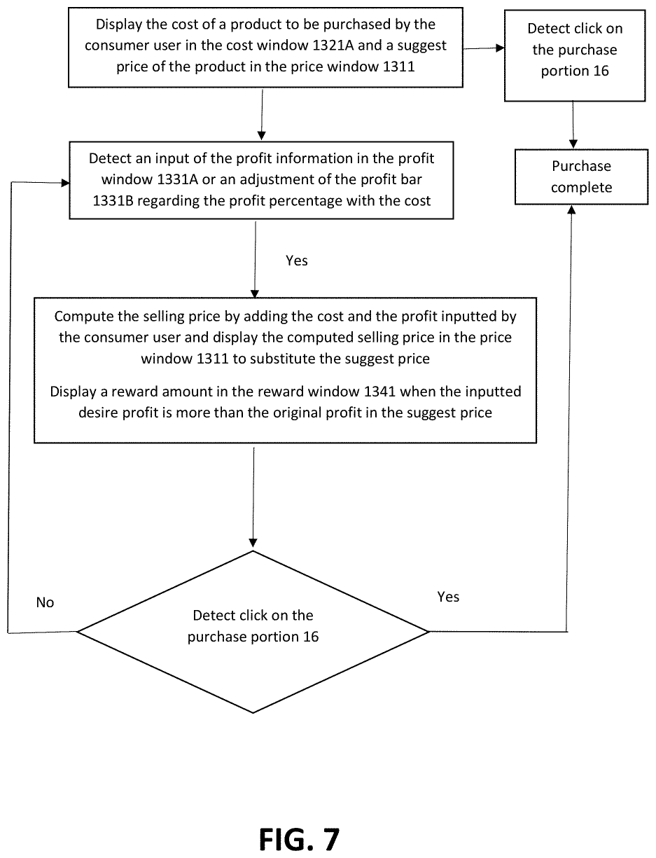

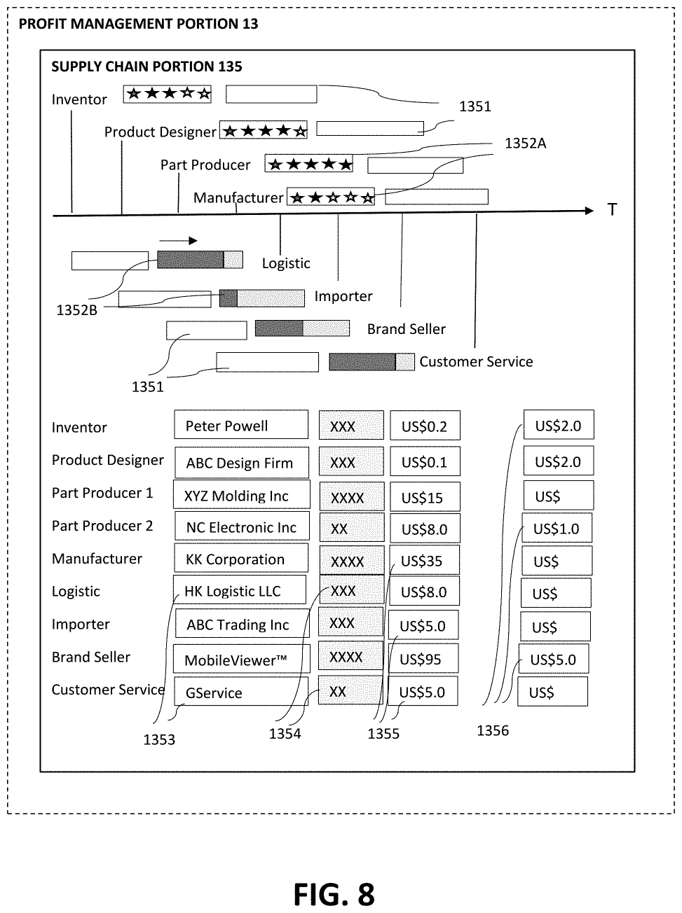

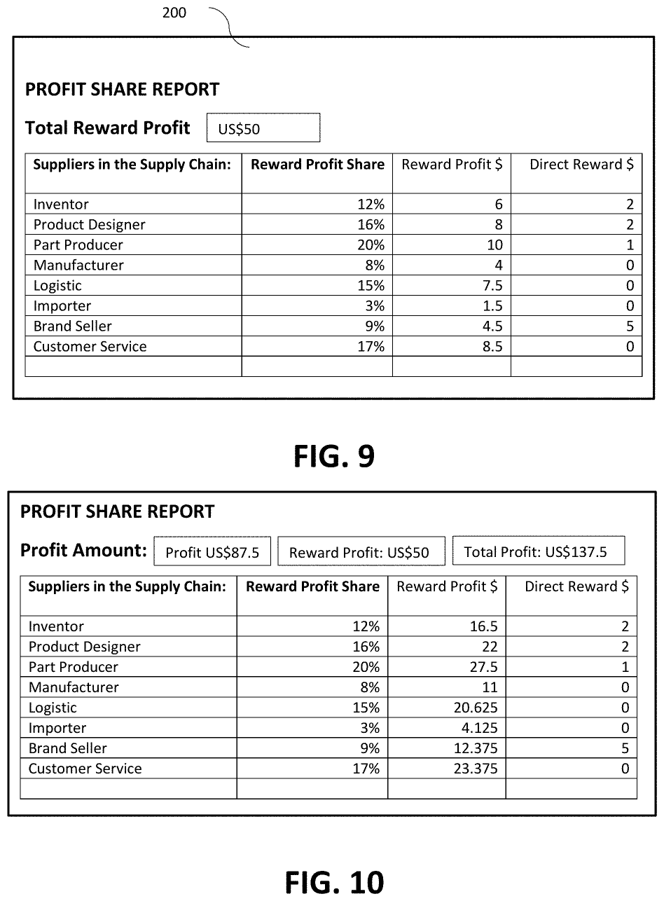

FIG. 4 is a perspective view of a user interface for displaying a change supplier according to a preferred embodiment of the present invention.

FIG. 5 is a schematic view of the profit management portion according to the preferred embodiment of the present invention.

FIG. 6 is a flow chart illustrating a profit adjusting method for the consumer user through the user interface according to the preferred embodiment of the present invention.

FIG. 7 is a flow chart illustrating an alternative mode of the profit adjusting method for the consumer user through the user interface according to the preferred embodiment of the present invention.

FIG. 8 is a schematic view showing the supply chain portion of the profit management portion according to the preferred embodiment of the present invention.

FIG. 9 is a schematic view illustrating a profit share report according to the preferred embodiment of the present invention.

FIG. 10 is a schematic view illustrating a profit share report according to an alternative mode of the preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

According to a preferred embodiment, the present invention provides a system for online marketing with supply chain profit management, which is a non-transitory computer readable medium, wherein the system comprises:

a computer usable medium 100 having computer-readable program code embodied in the medium to perform executable operations, the computer-readable program code comprising:

a first executable portion 1 for managing a plurality of marketing products on sale, wherein the first executable portion 1, which is embodied as a supply chain module 30 according to the preferred embodiment of the present invention, is configured, through a user interface 10, for:

providing access to a product information, including at least brand name and price of a product, such as a merchandise product or a service product, selected by a consumer user from the marketing products for purchasing, and presenting a profit information of the product, and

providing access to a plurality of suppliers in a supply chain of the product and a plurality of supplier information for the plurality of suppliers respectively, wherein each of the plurality of supplier information includes at least a contribution in production and marketing of the product;

a second executable portion 2, which is embodied as a profit module 20 according to the preferred embodiment of the present invention, operable to:

allow the consumer user who purchased the product to review and grade one or more of the plurality of suppliers in the supply chain of the product through the user interface 10; and

allow the consumer user to assign one or more profit shares with respect to one or more of the plurality of suppliers in the supply chain of the product through the user interface 10; and

a third executable portion 3 comprises a payment module 60, according to the preferred embodiment of the present invention, operable for receiving the one or more profit shares assigned by the consumer user and generating a profit share report for the plurality of suppliers in the supply chain of the product.

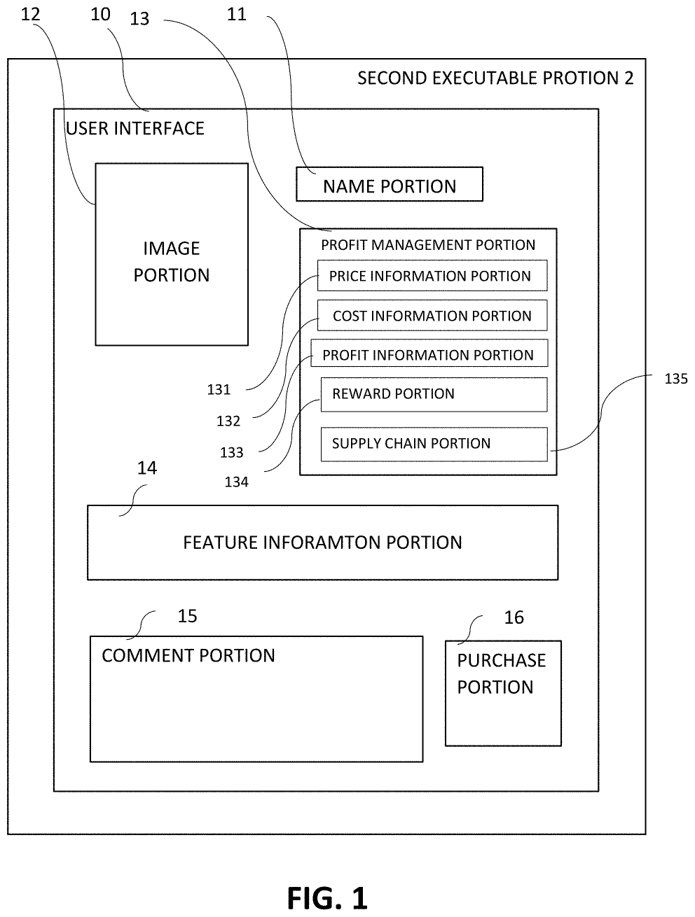

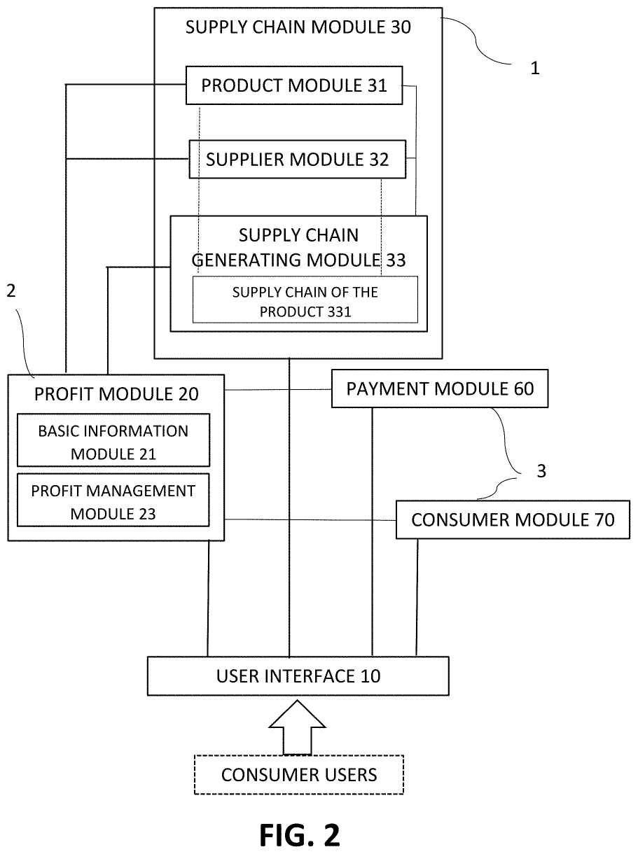

Referring to FIGS. 1 to 2, the user interface 10 of the first executable portion 1 of the system embodied as an online marketing platform according to the above preferred embodiment of the present invention is illustrated. The user interface 10 comprises a name portion 11, an image portion 12, a profit management portion 13, and a purchase portion 16. The name portion 11 displays a name of a product, which can be a merchandise product or a service product, on sale in the online marketing platform of the system of the present invention. The profit management portion 13 adjusts a profit of the product. In other words, the price of the product is adjustable through adjusting the profit of the product. The purchase portion 16 is able to be triggered an action of purchase, as shown in FIG. 5. In other words, after the purchase portion 16 is received an action, such as touch, click, slide, and so on, the purchase action is triggered. The product is sold. The profit management portion 13 is able to displays a cost information portion 132 for displaying a cost information of the product, a profit information portion 133 for displaying a profit information after the product is sold. Preferably, the profit information portion 133 is capable of editing. In other words, the profit of the product is capable of adjusting through the profit information portion 133. The profit information portion 133 provides filling in information such as a currency number as the profit information. In other words, through changing, for example, the number displayed in the profit information portion 133, the profit information of the product is adjusted. The user interface 10 further displays a price information portion 131. The price information portion 131 displays the price of the product.

The price information portion 131 displays a currency number as the price information of the product. Preferably, the price information of the product equals the cost information of the product plus the profit information of the product. In other words, the currency number of the price information portion 131 equals the currency number of the cost information portion 132 plus the currency number of the profit information portion 133. For example, if the price information is $500, the cost information can be $350 and the profit information will be $150. It is worth mentioning that the currency number of the price information, the cost information and profit information can also be replaced by a digit number or percentage information. For example, if the price information is selling price of the product such as $500, the cost information can be 55 representing 55% of the selling price and the profit information can be 45 representing 45% of the selling price. The profit management portion 13 further displays a reward portion 134. If a customer user believes the product is deserved a reward, the customer may fill a reward information, such as a currency number, into the reward portion 134 for an amount for the consumer user would like to reward on or more suppliers in the supply chain of the product additional. If the product is purchased by the customer user, the price information of the product and the reward information are charged from an account of the customer user.

Referring to FIG. 1, the user interface 10 further comprises a feature information portion 14 for displaying the feature of the product. The feature information portion 14 is able to display information regarding one or more features of the product. The features of the feature information portion 14 is able to help the customer user to determine whether the product is worth purchasing. The user interface 10 further comprises a comment portion 15 for displaying comments regarding to the product by the consumer user and a purchase portion 16 configured to allow the consumer user to click and trigger a purchase activity. The consumer user purchased the product is allowed to specify reasons or key factors of decision to purchase through the comment portion 15 as one or more of the ornamental design, the internal mechanism, functions or performance, the product or service brand, the packaging, the rapid and secure logistics service, the after customer service, the warranty or maintenance service, and etc.

As shown in FIG. 2, according to the preferred embodiment of the present invention, the system for online marketing with supply chain profit management comprises the profit module 20, the supply chain module 30, the payment module 60, and a consumer module 70. The profit module 20 is communicatively connected with the supply chain module 30, the payment module 60, and the consumer module 70. The profit module 20 acquires the product information from the supply chain module 30. The profit module 20 is generated via the user interface 10 for displaying the product information. The product information displayed, including the features of the product in the feature information portion 14, through the user interface 10 helps the customer user to understand the product for making decision to purchase the product. After the purchase portion 16 is received an action, such as click on the purchase portion 16 of the user interface 10, to trigger the purchase activity, the payment module 60 executes the payment operation. The payment of the product is paid to the account of the supplier of the product through the payment module 60. The consumer module 70 may be embodied to be provided in the third executable portion 3 or in an individual executable portion configured for recording the information of the consumer users who visited the user interface 10. The payment module 60 is communicatively connected with the consumer module 70. The payment module 60 is able to charge the consumer user according to the account of the consumer stored in the consumer module 70.

The supply chain module 30 comprises a product module 31 and a supplier module 32. The profit module 20 acquires the product information from the product module 31. The profit module 20 acquires the supplier information from the supplier module 32. The supply chain module 30 further comprises a supply chain generating module 33. The supply chain generating module 33 is communicatively connected with the product module 31 and the supplier module 32. The supply chain generating module 33 generates a supply chain of the product 331 through acquiring the product information from the product module 31 and acquiring the supplier information from the supplier module 32. It is worth mentioning that the supplier module 32 is able to provide the cost and the profit to the supply chain generating module 33. In other words, the supplier chain of the product 331 includes the supplier information, the product provided by the suppliers in the product supply chain, the cost and the profit of the product provided by the suppliers in the supply chain.

The profit module 20 further comprises a basic information module 21 and a profit management module 23. The basic information module 21 is communicatively linked with the profit management module 23. The basic information module 21 is communicatively linked with the product module 31 and the supplier module 32. The basic information module 21 acquires the product information from the product module 31. The basic information module 21 acquires the supplier information from the supplier module 32.

Referring FIGS. 1 and 2, the basic information module 21 controls the name portion 11 to display the name of the product or the brand of the product. The basic information module 21 controls the image portion 12 to display the image of the product. The basic information module 21 controls the feature information portion 14 to display the features of the product. The basic information module 23 controls the comments portion 15 to display the comments of the product. The profit management module 23 controls the profit management portion 13 to display information of the cost of the product, the profit of the product, and the price of the product. The profit management module 23 controls the profit management portion 13 to adjust the profit of the product in the profit information portion 133. The profit management module 23 is capable of adjusting the reward of the product in the reward portion 134.

As shown in FIGS. 1-3, the computer usable medium of the system for online marketing with supply chain profit management according to the preferred embodiment the present invention comprises at least one cloudy server 100 configured for communicating with at least one electronic device 40. The electronic device 40 comprises a processor 41, a screen 42, a storage device 43, a communication module 44 and a power supplier 46. The power supplier 46 is electronically connected with the processor 41, the screen 42, the storage device 43 and the communication module 44. The power supplier 46 provides power to the processor 41, the screen 42, the storage device 43 and the communication module 44. The electronic device 40 is configured to display the user interface 10 on the screen 42 for the consumer users to access and operate through the input device 45, wherein the process 41 is configured as an interface module to receive the data from the second executable portion 2 of the cloudy server 100 via the communication module 44 which is communicatively connected with the cloudy server 100 through a communication network such as Internet and display the received data through the screen 42. In other words, the process 41 generates the user interface 10 and displays the user interface 10 on the screen 42. The consumer user may adjust the profit of the product through the input device 45. Preferably, if the screen 42 is a touch screen, the consumer user may simply adjust the profit of the product through the touch screen 42. The processor 41 acquires the product information from the product module 31 of the supply chain module 30 of the second executable portion 2 through the communication module 44. The communication module 44 is capable of operatively connecting the communication network, such as internet. The communication module 44 provides a plurality connecting methods, such as network cable connection, WiFi, 5G, 4G, Bluetooth, and so on. The storage device 43 is configured for storing the product information, the customer information and the supplier chain information downloaded from cloudly server 100. The electronic device 40 further comprises an input device 45, such as keyboard, touch pad, or touch screen, for inputting information.

As shown in FIG. 4, the cloudy sever 100 refers to a sever configured to use a cloud technology. The electronic device 40 is communicatively connected with the cloudy sever 100. The computer usable medium embodied as the cloudy sever 100 comprises a server processor 101, a sever screen 102, a sever storage device 103, a server communication module 104, and a sever power supplier 106. The server process 101 is operatively connected with the sever screen 102, the sever storage device 103, the server communication module 104, and the sever power supplier 106. The sever power supplier 106 supplies power to the sever process 101, the sever screen 102, the sever storage device 103, and the sever communication module 104. The sever communication module 104 is communicatively connected with the communication module 44 of the electronic device 40. The sever storage device 103 storages the data of the supplier information, the product information and the consumer information. The cloudy server 100 is configured to provide the supply chain module 30. In other words, the supply chain module 30 is run in the sever processor 51. The sever processor 51 generates a supply chain of the product and sends the supply chain of the product to the processor 41 of the electronic device 40 of the consumer user and configured to control and display the supply chain of the product through the user interface 10. Furthermore, the profit of each of the suppliers of the supply chain is displayed through the user interface 10. The customer is capable of adjusting the profit of each of the suppliers in the supply chain of the product through the interface 10. The server processor 101 is also configured to provide the profit module 20 as the second executable portion 2. In other words, the profit module 20 is capable of being run in the server processor 101.

The profit module 20 is configured to be operated through the electronic device 40 of the consumer user. In other words, the processor 41 is defined as user interface processor for the consumer user to acquire the product information and the supplier information from the supply chain module 30, including the cost information of the product and the profit information of the product from the supply chain module 30 via the communication module 44. The supply chain module 30 is configured in server processor 51 to receive the request for acquiring the product information and the supplier information sent from the profit processor 41 via the server communication module 44. The supply chain process 51 acquires the product information and the supplier information of a specific product according to the inquiry of the consumer user from the sever storage device 53. The supply chain process 51 sends the supplier information to the processor 41 of the electronic device 40 of the consumer user via the sever communication module 104 and the processor 41 receives the supplier information and the product information through the communication module 44, wherein such supplier information and the product information are displayed through the user interface 10 on the screen 42 of the electronic device 40 of the consumer user.

Referring to FIGS. 1-5, the profit information portion 133 of the user interface 10 displayed on the screen 42 of the electronic device 40 of the consumer user is able to be adjusting through the input device 45 of electronic device 40 by the consumer user, wherein if the screen 42 and the input device 45 are combined as a touch screen that the user may simply operate and adjust the profit information of the profit information portion 133 through the touch screen. In other words, the customer user is allowed to adjust the profit of the product, executed by the profit management module 23 of the profit module of the second executable portion 2, through the profit information portion 133. For example, an end selling price, US$350, as price information is displayed on a price window 1311 in the price information portion 131 of the profit management portion 13, wherein a cost window 1321 is provided in the cost information portion 132 to display a cost information, such as an exact cost in currency number (US$262.5) or a percentage of the end selling price. The cost information can be displayed as a percentage number (e.g. 75%) 1321A and/or a cost percentage bar 1321B through the profit management module 23, which is a display bar with a corresponding portion (e.g. 3/4) proportional to the percentage of the cost for the end selling price in specific color. Such cost percentage can be a precise percentage of the actual cost (displayed as percentage number 1321A) or an approximate range percentage of the actual cost (displayed as the cost percentage bar 1321B) that, for example, the light grey portion of the bar illustrating the profit proportion and the dark grey portion of the bar illustrating the cost proportion.

As shown in FIGS. 5 and 6, the profit information portion 133 displayed on the screen 41 of the electronic device 40 of the consumer user has a profit window 1331A provided through the user interface 10 to display the profit of the product on sale in either currency number (e.g. US$87.5) or percentage number (25%) automatically. If the consumer user agrees to purchase the product with the end selling price listed in the price window 1311, the consumer user may simply click on the icon of the purchase portion 16 through the user interface.

The profit window 1331A is provided adjustable for the consumer user to freely input an assigned profit of the purchased product that the consumer user would like to pay to purchase the product, generally merely allowing the consumer user to input a number more the original listed profit number. For example, the consumer user really appreciates the purchased product and would like to pay an extra bonus profit to one or more of the suppliers in the supply chain of the product to be purchased, the consumer user may key in a new currency number (e.g. US$95.5) or a new percentage number (e.g. 30%) into the profit window 1331A of the profit information portion 133. Then, the selling price displayed in the price window 1311 will automatically update to the current agreed selling price (e.g. US$358) for the consumer user and a reward window 1341 provided in the reward portion 134 will display reward amount, e.g. US$8, that is the difference between the original profit amount (e.g. US$87.5) and the inputted new amount (e.g. US$95.5), so that when the consumer user click the purchase portion 16, the product will be sold with the updated selling price US$358 to the consumer user.

If the consumer user does not adjust the profit of the product, the reward window 134 would merely display US$0 originally. Also, the consumer user may also simply input a currency number, such as US$8, in the reward window 1341 as a reward amount as the extra bonus profit that the consumer user would like to additionally pay the suppliers in the supply chain of the product to be purchased, then the price information, the profit information displayed in the price window and the profit window 1331A will be adjusted accordingly to update the current selling price and profit in currency number or percentage number automatically by the system of the present invention.

Alternatively, the profit information portion 133 may also provide a profit bar 1331B instead of the profit window 1331A or in addition to the profit window 1331A, which is originally identical to cost percentage bar 1321B before any adjustment. The profit portion (light grey portion) of the profit bar 1331B is configured to be adjustable in length, such that when the consumer user touch the profit portion of the profit bar 1331B, the profit bar 1331B is triggered to activate to an adjustable mode that the consumer user may simply slide the profit portion of the profit bar 1331B towards its free end to extend its length, the proportional percentage of the profit of the product to be purchased will be increased accordingly in responsive to the sliding action. If the screen 41 displaying the user interface 10 is not a touch screen, the consumer user may use the input device 45 to click on the profit bar 1331B and operate to increase the length of the profit portion of the profit bar 1331B, wherein the proportion of the length of the profit portion of the profit bar 1331B reflects the proportional percentage of the profit that the consumer user agrees to add as bonus profit to one or more suppliers in the supply chain as a reward. At the same time, the reward window 1341 of the reward portion 134 displays the reward digit in exact currency number for the consumer user's information of how exactly much he or she agrees to pay for reward, and that the updated selling price in the price window 1311 and the profit information in the profit window are updated correspondingly.

Based on the profit management portion 13 disclosed in the present invention, as shown in FIG. 7, the online marketing platform can be an innovative product on sale platform or a social media configured merely to display products, such as merchandise product and/or service product, with the cost information listed in the cost window 1321A and/or cost bar 1321B of the cost information portion 132. On the price information portion, there may not provide end selling price in the price window 1311 or simply a suggest price in the price window 1311. The consumer user is allowed to input the assigned profit in the profit window 1331A of the profit information portion 133 that the assigned profit inputted is sent to the cloudy server 100 via the communication module 44, then the server processor 101 computes the selling price by adding the assigned profit and the cost and displays the computed selling price through the user interface 10 that is displayed in the price window 1311 to substitute the suggest price. Alternatively, the consumer user may also allow to input the profit percentage in percentage number the profit window 1331A in percentage number or to and/or to adjust the profit bar 1331B by sliding the profit portion of the profit bar 1331B, wherein the percentage number will also display correspondingly in the profit window 1331A. When the inputted assigned profit is more than the original profit in the suggest price, the additional profit is display as reward amount in the reward window 1341 automatically too.

When the consumer user adjusts by inputting a currency number or percentage number in the profit window 1331A of the profit information portion 133 or adjust the profit bar 1331B of the profit information portion by sliding the profit portion thereof. The adjusted profit of the product to be purchased is recorded in the processor 41 and sends to the server processor 101 of the cloudy server 100 which adjusts the selling price of the product and displays in the price window 1311 of the price information portion 131 via the user interface 10. If the consumer user agrees the selling price shown in the price window 1311 and clicks on the purchase portion 16, the selling price will be paid for the product from the consumer user's account or registered bank account, credit card or the like in the payment module 60. The payment module 60 of the third executable portion 3 processes the payment according to the agreed adjusted price.

According to the preferred embodiment, the second executable portion 2 of the system for online marketing with supply chain profit management further operably allows the consumer user who purchased the product to review the grade one or more of the suppliers in the supply chain of the product through the user interface 10 and allows the consumer user to assign one or more profit shares with respect to one or more suppliers in the supply chain of the product through the user interface 10. Referring to FIGS. 1 and 8, the profit management portion 13 further comprises a supply chain portion 135 which displays a supply chain of the purchased product which is generated by the supply chain of the product 331 of the supply chain generating module 33 of the supply chain module 30, preferably along a supply chain timeline T, including a listing of one or more suppliers who are collaborated suppliers in the supply chain associated with the product purchased by the consumer user, such as inventor, product designer, part or component producer, manufacturer, logistic, importer, seller, and etc., who have contributed in designing, making, producing, marketing, and selling the purchased product. The suppliers in the supply chain are displayed in order along the supply chain timeline T according to a sequence of collaborated suppliers in the supply chain contributed to the preparation and production of the product through time. A plurality of supplier information windows 1351 is provided in the supply chain portion 135 for the listed suppliers in the supply chain portion 135 along the supply chain timeline T respectively. Each of the supplier information windows 1351 displays the supplier information of the corresponding supplier, such as name, location, website, professional, experience, and so on, and what is contributed to the collaboration of the subject product on sale generated by supplier module 32 of the supply chain module 30. These information are provided by the end seller or each of the suppliers to the first execution portion 1 of the system to display, such that the first executable portion 1 is configured, through the user interface 10, for not only providing access to the product information, as shown in FIG. 1, including at least brand name, image, description, and price of a product selected by a consumer user from the marketing products for purchasing, and presenting a profit information of the product, but also providing access to the plurality of suppliers (as shown in FIGS. 1 and 8) in a supply chain of the product and a plurality of supplier information in the supplier windows 1351 for the plurality of suppliers respectively, wherein each of the plurality of supplier information includes at least a contribution in production and marketing of the product. In addition, the supplier windows 1351 of the supply chain portion 135 of the profit management portion 13 may further displays information of each of the suppliers in the supply chain of the product, including but not limited to the cost, profit, performance, and so on of each supplier in the supply chain.

As shown in FIG. 8, a plurality of supplier grading portions 1352A, 1352B is provided in the supply chain portion 135 of the second executable portion 2 with respect to the plurality of suppliers in the supply chain for allowing the consumer user to grad the favorite degrees thereof, wherein each of the supplier grading portions 1352A, 1352B is configured to allow the consumer user who purchased the product to review and grade the corresponding supplier in the supply chain of the product through the user interface 10 that allows the consumer user to assign one or more profit shares with respect to one or more suppliers in the supply chain of the product through the user interface 10. The supplier grading portions can be embodied as a first-type supplier grading portions 1352A which allows the consumer user to grade the specific supplier by clicking a predetermined number of symbols (such as stars) for example from one to five stars, wherein the stars can be replaced with dots or the like. The supplier grading portions can be embodied as a second-type supplier portions 1352B which is a grading bar allows the consumer user to grade the specific supplier by sliding along grading bar from one end towards the other end to grade the specific supplier from zero to 100%, wherein the percentage of the portion of grading bar to be shaded through sliding action on the grading bar 1352B represents the proportional percentage to be positively graded for this particular supplier. If the screen 41 of the electronic device 40 is a touch screen, the consumer user may simply touch the grading bar 1352B to trigger the grading operation and slide along the grading bar 1352B to grade. Alternatively, the consumer user may also use the input device 45, such as a mouse, to click on the specific star-type supplier grading portion 1352A to trigger the grading operation thereof and click on one or more stars to grade the corresponding supplier.

Please referring to FIG. 1, the feature information portion 14 provided through the user interface 10 displays features of the product on sale generated from the product module 31 of the supply chain module 30 and describes which supplier has contribution to such feature acquired from the supplier module 32 of the supply chain module 30. The comment portion 15 provided through the user interface 10 displays all comments inputted by consumer users who purchased the product before and allows the current consumer user to input his or her comment to this product. The purchased consumer user may specify the reason or key factor of decision to purchase as one or more of the ornamental design, the internal mechanism, the functions or performance, the product or service brand, the packaging, the rapid and secure logistics service, the after customer service, the warranty or maintenance service, and etc. in the comment portion 15.

The supply chain portion 135 of the profit management portion 13 may further comprises a plurality of name portions 1353 for displaying the name or brand of the suppliers respectively acquired from the supplier module 32 of the supply chain module 30, a plurality of work portions 1354 for displaying the name of the part(s) the supplier made or the work the supplier done acquired from the supply chain generating module 33 of the supply chain module 30, a plurality of profit information portions 1355 for displaying the profits for the corresponding suppliers for the corresponding parts or works thereof acquired from the supply chain generating module 33 of the supply chain module 30, and a plurality of supplier reward portions 1356.

In order to produce an excellence product, all suppliers of the product contribute efforts and intelligence that the consumer user who purchased the product would like to especially appreciate to provide specific reward to express appreciation and encourage this or these suppliers to produce better product in the future. For example, the consumer user who purchased the product may grade the purchased product with the supplier grading portions 1352A, 1352B described above and even specifically assign a reward to pay to specific suppliers in the supply chain through the supplier reward portions 1356. Based on satisfaction of the product and the information displayed in the features information portion 14 and the comments displayed in the comment portion 15, the consumer user may operate after the purchase of the product or relogin the user interface 10 related to this purchased product which stored in the first executable portion 1 in the system after the product purchased is received and experienced, and access the supply chain portion 135 of the profit management portion 13 through the user interface 10, wherein the consumer user may specific input a reward amount in specific supplier reward portion 1356 of that supplier. For example, if the consumer user especially likes the innovative and inventive concept, the industrial design, the quality of a specific component, and the branding of the product purchased, in addition to the selling price paid for the product, the consumer user may specifically input the specific reward amounts to the supplier reward portions 1356 of the inventor, product designer, the specific part producer, and the brand seller of the product respectively, as exemplary shown in FIG. 8. Then, corresponding funds will be charged from the consumer user's account and pay to the designated suppliers as bonus rewards respectively.

The basic information module 21 of the profit module 20 is configured to acquire the product information and the supplier information from the supply chain module 30, as shown in FIG. 2. The product module 31 of the supply chain module 30 is configured in the server process 101 for acquiring the product information from the server storage device 103. The supplier module 32 is configured in the server process 101 for acquiring the information related to the suppliers from the server storage device 103 to generate supplier information for the consumer user to access through at least the image portion 12 and the feature information portion 14 the user interface 10. The supply chain generating module 33 is configured in the server process 101 for generating the supply chain of the product 331 for the consumer user to access through supply chain portion 135 of the profit management portion 13, as shown in FIG. 8. The supply chain of the product 331 comprises the product information, the information of each part of the product, the suppliers of the parts and contributed works of the product, the cost and profit of each part of the product, the cost and profit of each contributed work of the product, and the price of each part and contributed work of the product, which are displayed in the supply chain portion 135 of the profit management portion 13 of the second executable portion 2. The sever processer 101 is configured to comprise the supply chain generating module 33 to generate the supplier chain information for the consumer user to access the supply chain along the timeline T through the supply chain portion 135 of the profit management portion 13. The supply chain information may be stored in the storage device 43 of the electronic device 40 of the consumer user upon request and approval.

Referring to FIG. 5, when the consumer user adjusts the profit percentage displayed in the profit window 1331A by inputting the assigned profit percentage or the profit bar 1331B by sliding the profit portion of the profit bar 1331B, the profit management module 23 of the profit module 20 controls the adjustment of the profit of the product to adjust the original profit to the assigned profit, the selling price and the reward amount and display in the profit window 133, price window 1311 and the reward window 1341 respectively. If the consumer user does not grade the suppliers in the supply chain through the supply chain portion 135 of the profit management portion 13 nor assigning any reward in the supplier reward windows 1356, the end seller of the product will receive amount of the selling price, including the assigned profit, from the online marketing platform, i.e. the system for online marketing with supply chain profit management of the present invention, as shown in FIG. 8. When the consumer user does grade the suppliers in the supply chain of the purchased product through the supply chain portion 135 of the profit management portion 13 of the second executable portion 2, the assigned grades by the consumer user in the supplier grading portions 1352A, 1352B are sent to the third executable portion 3 which processes a computation of the profit share of each suppliers in the supply chain according to the assigned grades by the consumer user in the supplier grading portions 1352A, 1352B and generates a profit share report 200, as shown in FIG. 9, for the suppliers in the supply chain of the product.

As shown in FIG. 8, for first-type (star type) supplier grading portions 1351A, five stars in the supplier grading portions 1351A represents 100%. For example, three stars assigned for the inventor represents 60% (60 points), four stars assigned for the product designer represents 80% (80 points), five stars assigned for the part producer represents 100% (100 points), and two stars assigned to the manufacture represents 40% (40 points). For second-type (bar type) supplier grading portions 1351B, the full bar length represents 100% and thus the percentage of the profit portion in the full bar represents the percentage of the assigned profit to this supplier. For example, 75% profit portion assigned for the logistic company represents 75 points, 15% profit portion assigned for the importer represents 15 points, 45% profit portion assigned for the brand seller represents 45 points, and 85% profit portion assigned for the customer service represents 85 points. The total point sum of the inventor, product designer, part producer, manufacturer, logistic, importer, brand seller, and customer service is 500 points. Accordingly, the reward amount of the additional profit assigned by the consumer user displayed in the reward portion 134, for example US$50, will be computed by the third executable portion 3 to divide into proportional shares for the suppliers in the supply chain of the product. The reward amount US$50 is divided by the total point sum 500 points to obtain a reward unit 0.1 (50/500=0.1). Therefore, the reward profit share to the inventor is US$6 (60 points×0.1), the reward profit share to the product designer is US$8 (80 points×0.1), the reward profit share to the part producer is US$10 (100 points×0.1), the reward profit share to the manufacturer is US$2 (20 points×0.1), the reward profit share to the logistic company is US$7.5 (75 points×0.1), the reward profit share to the importer is US$1.5 (15 points×0.1), the reward profit share to the brand seller is US$4.5 (45 points×0.1), and the reward profit share to the customer service is US$8.5 (85 points×0.1). The profit shares of the suppliers in the supply chain are embodied to be displayed on the profit information portions 1355 of the supply chain portion 135 of the profit management portion 13 respectively as shown in FIG. 8. It is appreciated that the consumer user is also allowed to directly input the profit number in currency number in the profit information portions 1355 for the respective suppliers in the supply chain for assigning profit shares to the suppliers and then the system will not need to compute the profit shares for the suppliers in the supply chain of the product, wherein the consumer users are still allowing to review and grade the suppliers through the supplier windows 1351 and the supplier grading portions 1352A, 1352B for information and reference to the suppliers in the supply chain.

The profit share report 200 displays the reward profit shares for the suppliers in the supply chain of the products, and each of the suppliers in the supply chain of the product will receive the corresponding reward share amount from the system which received the reward from the consumer user through the payment module 60. It is worth mentioning that other computation methods are also applicable in the present invention, and the above computation method is merely an embodying example disclosed in the present invention. The system of the present invention is able to distribute the total profit to the listed suppliers in the supply chain based on designated ratios or proportions suggested by the consumer user and according to the reviews to the listed suppliers in the supply chain of the product by the consumer user who purchased the product

Further, when the consumer user does assign and pay specific rewards displayed in the supplier reward windows 1356 of the supply chain portion 135 of the profit management portion 13, as shown in FIG. 8, the corresponding reward amount for the specific supplier in the supply chain of the product will be received from the consumer user and paid to the specific supplier through the payment module 60 of the third executable portion 3 which distributes the reward amount to the specific supplier's account after receiving the payment of the consumer user of the purchased product. The first executable portion 1 further receives a profit margin of the product from the online seller, which would be a profit proportion or percentage of the selling price of the product.

Referring to FIG. 7, when the suppliers in the supply chain choose to allow the consumer user to assign profit shares through the user interface 10 of the system for online marketing with supply chain profit management (the online marketing platform), the grades inputted by the consumer user in the supplier grading portions 1352A, 1352B will be computed by the second executable portion 2 to generate the profit shares of the suppliers in the supply chain of the product according to the assigned grades and the assigned profit in profit information portion 133 and the reward portion 134 proportionally. For example, as shown in FIG. 10, if the end selling price of the product is US$350, the profit percentage is 25%, that is US$87.5, and the reward profit is US%50, the total profit amount will be US$137.5. Accordingly, the profit shares in percentage of the inventor, product designer, part producer, manufacturer, logistic company, importer, brand seller, and the customer servicer are 12%, 16%, 20%, 8%, 15%, 3%, 9% and 17% respectively based on the grading of the suppliers in the supply chain of the product as shown in the FIG. 8 as an example. Therefore, the profit share amounts for the inventor, product designer, part producer, manufacturer, logistic company, importer, brand seller, and the customer servicer are US$16.5, US$22, US$27.5, US$11, US$20.625, US$4.125, US$12.375, and US$23.375 respectively. This grading and profit assigning operations by the consumer users is specifically preferred to be used for pre-ordering a particular product via the online marketing platform, such as Kickstarter, wherein a product can be displayed before actual selling for consumer users to view and explain the pre-ordering product through the feature information portion and give comments through the comment portion. The displayed product for pre-order may display its cost, even the cost of each supplier in the supply chain of this product, and allow the consumer users to pre-order the displayed product and assign profit to the product, even profits to each suppliers in the supply chain of the product. The profit share report may be a summarize report to add up the assigned profit by all consumer users to all suppliers in the supply chain of the product, so that it is a valuable information to encourage and support the suppliers to produce the product collaboratively.

As shown in FIG. 8, the name portions 1353 of the supply chain portion 135 of the profit management portion 13 is preferred to be a drop box that when the consumer user click on one of the name portions 1353, an extended window is displayed to display all potential suppliers of that part, work, brand, and etc. for the consumer user to select by clicking on the particular name of the supplier listed and assign profit or share of profit or specific reward therefor. Then, the online seller or brand name seller of that pre-ordered product may provide service for the purchasing consumer users to produce the pre-ordered product by giving orders to the selected suppliers to form the supply chain of the pre-ordered product and profit from such production service. Alternatively, through such pre-ordering system, the consumer user who is the one paying for the product may become a substantial end purchaser (buyer) to all suppliers in the supply chain of the product and determine the shares of the profit of the product among the collaborated suppliers in the supply chain.

It is worth mentioning that the suppliers in the supply chain to be listed for access through the user interface 10 can be determined by the seller of the product or requested by the online marketing platform. The seller of the product may merely select some of the suppliers which are rewardable and valuable in producing a good product of the type. The system for online marketing with supply chain profit management according to the present invention can be an online marketing platform, a social media platform, or any other online platform that a consumer is allowed to purchase a product, such as a merchandise product or a service product. When the online platform is a social media platform for individual members whose identity is consumer and/or supplier's personnel to chat, share, post, and inform information related to their comments in products or services purchased or provided, purchasing experiences, and works contributed to a supplier of a product or service, all registered members are able to contact with each other, to follow another member, and to reward a specific member.

In view of above, the present invention provides a method and system for managing profits between collaborated suppliers (e.g. manufacturers, designers, sellers, and etc.) in a supply chain associated with a product (such as a merchandise product or a service product) provided by the suppliers. Aspects of the invention are targeted at online marketing platforms where there is multiple channel selling, such as online marketplaces, online auction and/or shopping websites, brand name shopping websites, offline shopping store with online shopping and/or ecommerce supports, social media platform, and etc. Also, the system for online marketing with supply chain profit management of the present invention is capable of presenting information of specific suppliers in a supply chain of a product on sale, so as to allow consumer users who purchased the product to review, record, track the suppliers through the suppliers information windows of the suppliers in the supply chain, and to allow consumers who purchased the product to assign profit shares directly to or by grading one or more suppliers in the supply chain of the product through the supplier grading portions of the suppliers in the supply chain displayed on the online marketing platform.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A system for online marketing with supply chain profit management, comprising:
a computer usable medium having computer-readable program code embodied in the medium to perform executable operations, the computer-readable program code comprising:
a first executable portion for managing a plurality of marketing products on sale, wherein the first executable portion is configured, through a user interface, to;
provide access to a product information, including at least brand name and price of a product selected by a consumer user from the marketing products for purchasing, and presenting a profit information of the product; and
provide access to a plurality of suppliers in a supply chain of the product and a plurality of supplier information for the plurality of suppliers respectively, wherein each of the plurality of supplier information includes at least a contribution in production and marketing of the product;
a second executable portion operable to:
allow the consumer user who purchased the product to review and grade one or more of the plurality of suppliers in the supply chain of the product through the user interface; and
allow the consumer user to assign one or more profit shares with respect to one or more of the plurality of suppliers in the supply chain of the product through the user interface; and
a third executable portion operable for receiving the one or more profit shares assigned by the consumer user and generating a profit share report for the plurality of suppliers in the supply chain of the product.

2. The system, as recited in claim 1, wherein the second executable portion comprises a profit management portion which comprises a supply chain portion displayed through the user interface for displaying the suppliers of the supply chain of the product to be purchased.

3. The system, as recited in claim 2, wherein a supply chain timeline in the supply chain portion with the plurality of suppliers displayed in order along the supply chain timeline according to a sequence of the suppliers in the supply chain contributed to preparation and production of the product through time.

4. The system, as recited in claim 2, wherein a plurality of supplier grading portions is provided in the supply chain portion for the suppliers in the supply chain respectively and configured to allow the consumer user to grade the corresponding suppliers in the supply chain.

5. The system, as recited in claim 3, wherein a plurality of supplier grading portions is provided in the supply chain portion for the suppliers in the supply chain respectively and configured to allow the consumer user to grade the corresponding suppliers in the supply chain.

6. The system, as recited in claim 2, wherein a plurality of supplier information windows is provided in the supply chain portion for the suppliers in the supply portion respectively for displaying supplier information of the corresponding suppliers respectively.

7. The system, as recited in claim 5, wherein a plurality of supplier information windows is provided in the supply chain portion for the suppliers in the supply portion along the supply chain timeline respectively for displaying supplier information of the corresponding suppliers respectively.

8. The system, as recited in claim 2, wherein the supply chain portion further provides a plurality of profit information portions for displaying profits of the suppliers in the supply chain of the product to be purchased respectively.

9. The system, as recited in claim 4, wherein the supply chain portion further provides a plurality of profit information portions for displaying profits of the suppliers in the supply chain of the product to be purchased respectively.

10. The system, as recited in claim 5, wherein the supply chain portion further provides a plurality of profit information portions for displaying profits of the suppliers in the supply chain of the product to be purchased respectively.

11. The system, as recited in claim 8, wherein the profit information portions are configured to allow the consumer user purchased the product to assign profit shares by inputting profit data through one or more of the profit information portions for one or more of the corresponding suppliers.

12. The system, as recited in claim 10, wherein the profit information portions are configured to allow the consumer user purchased the product to assign profit shares by inputting profit data through one or more of the profit information portions for one or more of the corresponding suppliers.

13. The system, as recited in claim 9, wherein the profit information portions are configured to display profit information for the suppliers in the supply chain of the product respectively, wherein the profit information of each of the suppliers in the supply chain is computed based on the grading of supplier grading portions by the consumer user who purchased the product.

14. The system, as recited in claim 10, wherein the profit information portions are configured to display profit information for the suppliers in the supply chain of the product respectively, wherein the profit information of each of the suppliers in the supply chain is computed based on the grading of supplier grading portions by the consumer user who purchased the product.

15. The system, as recited in claim 2, wherein the profit management portion further provides a reward portion which has a reward window configured to allow the consumer user to input a reward amount for the purchased product in addition to a selling price of the product.

16. The system, as recited in claim 5, wherein the profit management portion further provides a reward portion which has a reward window configured to allow the consumer user to input a reward amount for the purchased product in addition to a selling price of the product.

17. The system, as recited in claim 10, wherein the profit management portion further provides a reward portion which has a reward window configured to allow the consumer user to input a reward amount for the purchased product in addition to a selling price of the product.

18. The system, as recited in claim 12, wherein the profit management portion further provides a reward portion which has a reward window configured to allow the consumer user to input a reward amount for the purchased product in addition to a selling price of the product.

19. The system, as recited in claim 14, wherein the profit management portion further provides a reward portion which has a reward window configured to allow the consumer user to input a reward amount for the purchased product in addition to a selling price of the product.

20. The system, as recited in claim 2, wherein the supply chain portion further provides a plurality of supplier reward portions with respect to the suppliers in the supply chain of the product respectively, wherein each of the supplier reward portions is configured to allow the consumer user to assign a reward to the corresponding supplier in the supply chain.

21. The system, as recited in claim 5, wherein the supply chain portion further provides a plurality of supplier reward portions with respect to the suppliers in the supply chain of the product respectively, wherein each of the supplier reward portions is configured to allow the consumer user to assign a reward to the corresponding supplier in the supply chain.

22. The system, as recited in claim 10, wherein the supply chain portion further provides a plurality of supplier reward portions with respect to the suppliers in the supply chain of the product respectively, wherein each of the supplier reward portions is configured to allow the consumer user to assign a reward to the corresponding supplier in the supply chain.

23. The system, as recited in claim 12, wherein the supply chain portion further provides a plurality of supplier reward portions with respect to the suppliers in the supply chain of the product respectively, wherein each of the supplier reward portions is configured to allow the consumer user to assign a reward to the corresponding supplier in the supply chain.

24. The system, as recited in claim 14, wherein the supply chain portion further provides a plurality of supplier reward portions with respect to the suppliers in the supply chain of the product respectively, wherein each of the supplier reward portions is configured to allow the consumer user to assign a reward to the corresponding supplier in the supply chain.
